(19) United States
(12) Patent Application Publication
(10) Pub. No.: US 2025/0211833 A1
(43) Pub. Date: Jun. 26, 2025

(54) Method and System for Generating Snapshot of Video Under Recording

(71) Applicant: VIA TECHNOLOGIES, INC., New Taipei City (TW)

(72) Inventors: Hsueh-Chieh Chen, New Taipei City (TW); Syu-Jhih Hong, New Taipei City (TW); Chun-Hua Tseng, New Taipei City (TW); Yao-Te Wang, New Taipei City (TW)

(21) Appl. No.: 18/636,630

(22) Filed: Apr. 16, 2024

(30) Foreign Application Priority Data
Dec. 25, 2023 (TW) 112150570

(51) Int. Cl. H04N 21/8352; H04N 21/231; H04N 21/239

(52) U.S. Cl. CPC H04N 21/8352; H04N 21/231; H04N 21/2393

(57) ABSTRACT

A method and system for generating snapshot of video under recording, wherein the method comprises retrieving a header information of the original video file as a first header information when a read instruction requesting the original video file under recording is received; replacing a first unique material identifier (UMID) stored in the first header information with a second UMID to form a second header information; storing the second header information as a header information of a snapshot header file; and generating a snapshot video file and providing the snapshot video file to a client when the snapshot header file is requested by the client, wherein a header information of the snapshot video file is generated in accordance with the second header information, and a snapshot content of the snapshot video file is generated by retrieving a part of the original video file defined by the snapshot header file.

### FIELD OF THE INVENTION

The present invention relates to a method and system for generating snapshot of video. More specifically, the present invention relates to a method and system for generating snapshot of video under recording.

### BACKGROUND OF THE INVENTION

In order to increase work efficiency, users may want to start playing or editing videos (such as Material Exchange Format, MXF file) before completing the video recording procedure. Therefore, a copy of the video that is under recording will be made available to users by the computer system. However, two advantages would be brought out by generating such a copy. The first disadvantage is that content of the copied video is duplicate of a part of content of the final recorded video and occupies a lot of storage spaces. The second disadvantage is that it is time consuming to perform the copy procedure and, furthermore, the efficiency of video playback and editing would be affected thereby.

### SUMMARY OF THE INVENTION

In view of the drawbacks existed in the technique described above, the present invention provides a method and system for generating snapshot of video under recording to reduce the waste of storage space and the problem of efficiency reduction caused by copying videos.

In one aspect of view, the present invention provides a method for generating snapshot of video under recording as described in the embodiments below. The method is adapted for providing a current content of an original video file when a read instruction is received while recording the original video, which comprises retrieving a header information of the original video file stored in a server as a first header information when the read instruction requesting the original video file is received while recording the original video file; replacing a first unique material identifier stored in the first header information with a second unique material identifier to form a second header information; storing the second header information as a header information of a snapshot header file; and generating a snapshot video file and providing the snapshot video file to a client when the snapshot header file is requested by the client, wherein, a header information of the snapshot video file is generated in accordance with the second header information, and a snapshot content of the snapshot video file is generated by retrieving a part of the original video file defined by the snapshot header file.

In one embodiment, the second header information includes a time length of the current content, a size of the current content and a number of frame of the current content.

In one embodiment, the snapshot header file further comprises a metadata comprising a storage path where the original video file is stored in the server. Furthermore, the step of generating the snapshot video file and providing the snapshot video file to the client when the snapshot header file is requested by the client, comprises providing a first content to the client when an address offset obtained due to requesting the snapshot header file is not greater than a size of the second header information, wherein the first content is a first data located within the second header information and corresponded to the address offset; and providing a second content to the client when the address offset obtained due to requesting the snapshot header file is greater than the size of the second header information, wherein the second content is a second data located within the original video file pointed by the storage path and corresponded to the address offset.

In another aspect of view, the present invention provides a system for generating snapshot of video under recording as described in the embodiments below. The system comprises a server being adapted for storing an original video file, wherein the original video file comprises a first header information, and a first unique material identifier; and a client electrically coupled to the server, wherein, when the original video file is under recording and a read instruction issued from the client for requesting the original video file is received by the server, the server retrieves the first header information, replaces a first unique material identifier stored in the first header information with a second unique material identifier to generate a second header information of a snapshot header file; and when the snapshot header file is requested by the client, the server generates a snapshot video file and providing the snapshot video file to the client, wherein, a header information of the snapshot video file is generated in accordance with the second header information, and a snapshot content of the snapshot video file is generated by retrieving a part of the original video file defined by the snapshot header file.

In one embodiment, the second header information includes a time length of the current content, a size of the current content and a number of frame of the current content.

In one embodiment, the snapshot header file further comprises a metadata comprising a storage path where the original video file is stored in the server. Furthermore, the server provides a first content to the client when an address offset obtained due to requesting the snapshot header file is not greater than a size of the second header information and provides a second content to the client when the address offset obtained due to requesting the snapshot header file is greater than the size of the second header information, wherein the first content is a data located within the second header information and corresponded to the address offset and the second content is a data located within the original video file pointed by the storage path and corresponded to the address offset.

In summary, by using the technique solutions provided above, the method and system for generating snapshot of video under recording would not copy the content of the original video file that is under recording but generates a snapshot header file which occupies limited storage space. Therefore, the storage space would not be heavily wasted, and the efficiency of video playing and editing would not be affected by copying content of the original video file.

### BRIEF DESCRIPTION OF THE DRAWINGS

FIG. 1 is a circuitry block diagram of a system for generating snapshot of video under recording in accordance with one embodiment of the present invention.

FIG. 2 is a flow chart of a method for generating snapshot of video under recording in accordance with one embodiment of the present invention.

FIG. 3 is a schematic diagram of a video file and a snapshot header file in accordance with one embodiment of the present invention.

FIG. 4 is a flow chart showing how a snapshot header file is built in accordance with one embodiment of the present invention.

FIG. 5A is a schematic diagram showing contents of the header information of the original video file or the snapshot header file in accordance with one embodiment of the present invention.

FIG. 5B is a schematic diagram showing contents of the metadata of the snapshot header file in accordance with one embodiment of the present invention.

### DETAILED DESCRIPTION OF PREFERRED EMBODIMENTS

The invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

It is also noted that, in order to make the description be easily understood by those with ordinary skill in the art, a first unit electrically coupled to a second unit means that electronic signals could be transmitted between the first unit and the second unit, and, unless other limitations are made, transmission of the electronic signals could be unidirectional or bidirectional, and transmitting method of the electronic signals could be wired or wireless.

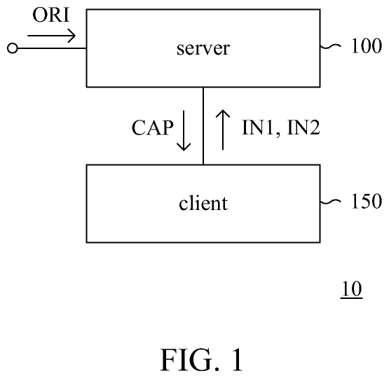

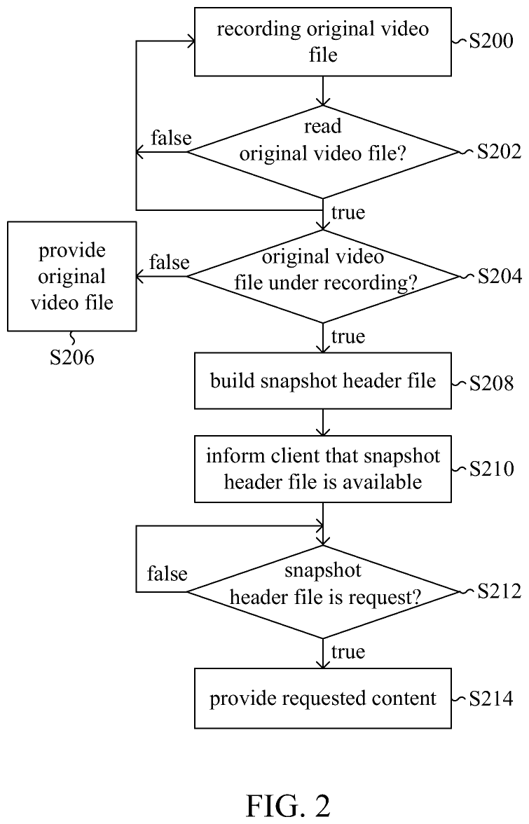

Please refer to FIG. 1, which is a circuitry block diagram of a system for generating snapshot of video under recording in accordance with one embodiment of the present invention. In this embodiment, the snapshot system 10 adapted for generating snapshot of video under recording comprises a server 100 and a client 150. The server 100 is capable of receiving electronic data ORI generated from an image generating apparatus. The client 150 is electrically coupled to the server 100 so that electronic signals could be transmitted between the client 150 and the server 100. In order to achieve the effect of the present embodiment, not only the operations would be performed internally by the server 100 and the client 150, respectively, but also transaction of electronic signals would be made between the server 100 and the client 150. The technique solutions would be described in detail with reference to FIG. 1 and FIG. 2.

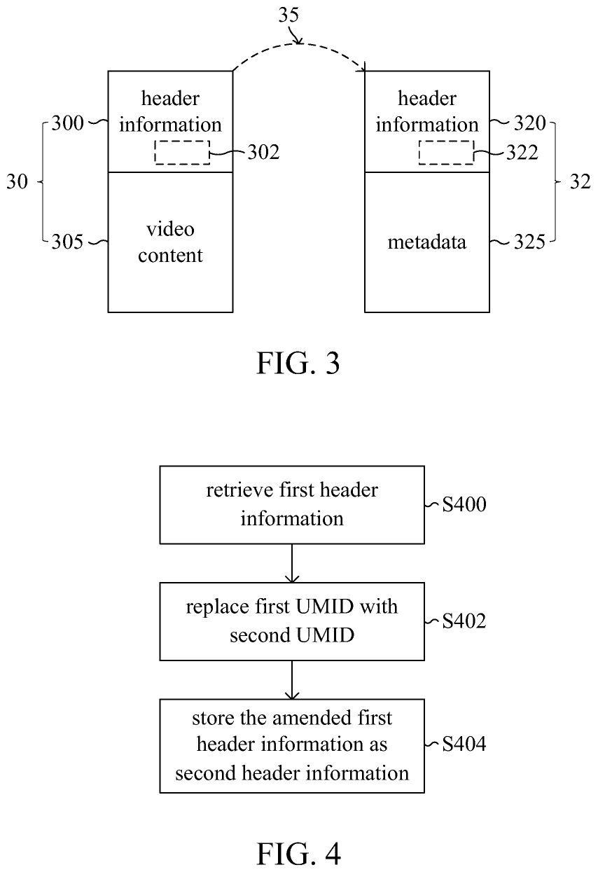

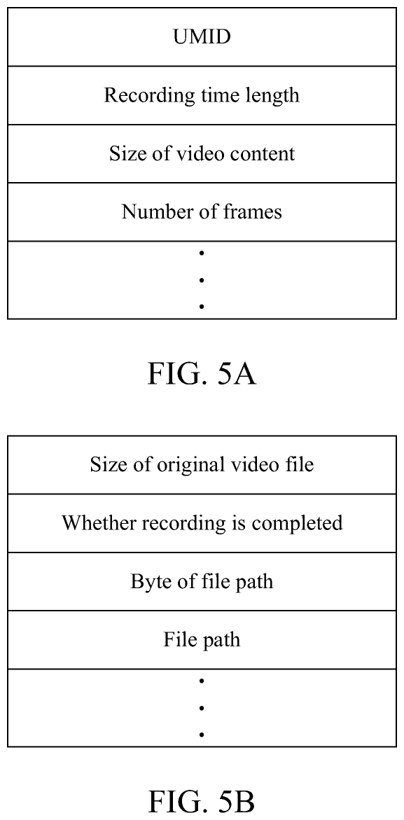

Please also refer to FIG. 2, which is a flow chart of a method for generating snapshot of video under recording in accordance with one embodiment of the present invention. In this embodiment, the electronic data ORI is generated by an image capture procedure performed in an external image source. The electronic data ORI is transmitted to the server 100 from the external image source, and the server 100 gradually receives the electronic data ORI and stores the received electronic data ORI as part of the content of an original video file (Step S200). In general, the original video file stored in the server 100 comprises two sub-parts. One of the two sub-parts is used for storing data of each frame in the original video file, and another one of the two sub-parts is used for storing parameters related to the original video file. Please also refer to FIG. 3, which is a schematic diagram of a video file and a snapshot header file in accordance with one embodiment of the present invention. In this embodiment, the original video file 30 comprises the header information 300 and the video content 305, wherein the data of the frames of the original video file 30 are stored in the video content 305, and the unique material identifier (UMID) and the parameters related to the original video file, such as the recording time length of the original video file 30 so far, the size of the video content 305 so far, or the number of frames stored in the video content 305 so far, are stored in the header information 300 as shown in FIG. 5A.

After storing the electronic data ORI into the original video file 30 is started in the step S200, it is started to determine by the server 100 that whether a read target requested by a read instruction IN1 received by the server 100 is the original video file 30 (step S202). When the read target requested by the read instruction IN1 is not the original video file 30, the server 100 processes the read instruction IN1 in accordance with normal procedures and continues receiving and storing the electronic data ORI. On the contrary, when the read target requested by the read instruction IN1 is the original video file 30, the server 100 would determine whether the original video file 30 is still under recording (step S204) in addition to continue receiving and storing the electronic data ORI. When the result of the determination operation performed in the step S204 is false, the flow goes to step S206 and the server 100 would provide the original video file 30 as an output result CAP to the client 150 directly because the operations for recording the original video file 30 have been completed. On the other hand, when the result of the determination operation performed in the step S204 is true, the flow goes to the step S208 and the server 100 would build a snapshot header file 32 which corresponds to the read instruction IN1 in accordance with the header information 300 of the original video file 30 because the operations for recording the original video file 30 are not completed, or, in other words, the original video file 30 is still under recording.

Please also refer to FIG. 4, which is a flow chart showing how a snapshot header file is built in accordance with one embodiment of the present invention. In this embodiment, the header information 300 of the original video file 30 would be copied through a file building procedure 35 in the step S400 when the server 100 determines that it is necessary to build the snapshot header file. After copying the header information 300 of the original video file 30, the unique material identifier (UMID) 302 of the copied header information is replaced with a different UMID 322 in the step S402. Finally, in the step S404, the copied header information with the different UMID 322 is stored as the header information 320 of the snapshot header file 32 built previously.

It is noted that, in order to simplify the description, the header information 300 of the original video file 30 is also referred to as a first header information hereinafter, the UMID 302 is also referred to as a first UMID hereinafter, the header information 320 of the snapshot header file 32 is also referred to as a second header information hereinafter, and the different UMID 322 is also referred to as a second UMID hereinafter. Furthermore, it is noted that the first UMID is different from the second UMID.

By placing the required information in the snapshot header file 32, the output result CAP could be obtained by the operation system controlling the server 100 through reading the snapshot header file 32, and, therefore, copying the video content 305 to the snapshot header file 32 can be avoided. For example, the server 100 (or the operating system or file system operated thereon) could be designed to retrieve the address ranges in which the video content 305 is stored during the file building procedure 35 by referring to the stored information and the location where the original video file 30 is stored when some information, such as the recording time length of the original video file 30 so far, the size of the video content 305 so far, or the number of frames stored in the video content 305 so far, is stored in the header information 300, and the retrieved address ranges could also be written into the header information 320 during the file building procedure 35. In another example, when an additional storage space for storing metadata 325 is also included in the snapshot header file 32, the address ranges described above could be stored into the additional storage space as a part of the metadata 325.

In practical, the formats of the header information 300 and the header information 320 could be different. In order to simplify the practical application, in one embodiment, it is possible to design the file building procedure 35 to copy the header information 300 as a copied header information, replace the UMID 302 in the copied header information with the UMID 322 and write the recording time length of the original video file 30 so far in the copied header information as the video playback time length, and store the amended copied header information into the snapshot header file 32 as the header information 320. By doing so, issues generated due to different formats of the header information 300 and the header information 320 could be eliminated. Furthermore, the server 100 could also write parameters as shown in FIG. 5B, such as the size of the original video file 30, whether the recording of the original video file 30 is completed, bytes of the file path of the original video file 30, file path of the original video file 30, etc., into the metadata 325 of the snapshot header file 32. By doing so, the data of the video content 305 could be easily obtained in accordance with the content stored in the metadata 325 by the server 100 when it is necessary.

It is noted that, although the header information 320 is formed by copying the header information 300 and amending the copied header information before writing the amended header information into the snapshot header file 32 in the embodiments described above, the header information 320 can be formed by directly copying the header information 300 into the snapshot header file 32 and then writing correct content thereinto. The adjustment could be accomplished by those with ordinary skill in the art in accordance with the technique solutions provided in the specification and would not be described in detail here.

Please refer to FIG. 2 again. After applying the technique solutions provided above or any other approaches, the snapshot header file 32 could be built in the file system of the server 100 by performing the step S208. After building the snapshot header file 32, the server 100 would inform the client 150 in the step S210 that the video requested by the read instruction IN1 could be obtained by accessing the snapshot header file 32. At the same time, the snapshot header file 32 could also be available by any user or client who connects to the server 100.

After informing the client 150 that the snapshot header file 32 is ready for accessing, the server 100 could follow normal procedures in the step S212 to determine whether a read request for requesting the snapshot header file 32 is received from any client connected to the server 100. When the result of determination performed in the step S212 is false, the server 100 continues normal work. On the contrary, when the result of determination performed in the step S212 is true, a snapshot video file could be generated and provided to the client issuing the corresponded read request in accordance with contents of the snapshot header file 32, which includes the header information 320 and, when existed, the metadata 325 in the step S214.

In one embodiment, the header information of the snapshot video file provided by the server 100 is generated in accordance with the header information 320, wherein the UMID of the snapshot video file should be the same as the UMID 322. By doing so, operation confusion occurred while accessing the video with UMID 322 later could be prevented.

Furthermore, take the embodiment writing the parameters, such as the size of the original video file 30, whether the recording of the original video file 30 is completed, bytes of the file path of the original video file 30, file path of the original video file 30, etc., into the metadata 325 of the snapshot header file 32, as an example, the server 100 could easily retrieve the data, which is defined by the size of the original video file at the time the snapshot header file 32 being built and the file path of the original video file 30, from the video content 305. After that, the retrieved data is provided to the client 150 who issues the corresponded read request as the output result CAP.

From another point of view, in one embodiment, after user operates the client 150 to issue the read instruction IN1 to the server 100 for requesting the original video file 30, the client 150 would be acknowledged by the server 100 that the required data could be obtained through reading the snapshot header file 32. Therefore, a read instruction IN2 whose target is the snapshot header file 32 would be issued from the client 150 to the server 100 for retrieving the data required by the user, and the output result CAP could be obtained accordingly. In one embodiment, a plurality of read instructions IN1 might be received by the server 100 before the recording procedure of the original video file 30 is completed, that is, users might want to access the original video file 30 at different time during video recording. For each of the read instructions IN1, a corresponded snapshot header file 32 would be built by the server 100 in accordance with the header information 300 retrieved at the time receiving the corresponded read instruction IN1. Therefore, a plurality of snapshot header files 32 could exist in the server 100 although only one snapshot header file 32 is shown in FIG. 3. The header information 320 of each snapshot header file 32 contains a UMID 322 different from that of other snapshot header file 32 and the parameters related to the original video file 30 described above. Furthermore, each of the snapshot header files 32 could contain the metadata 325 different from others for storing the information described above. After building the corresponded snapshot header file 32, the client 150 is informed by the server 100 that the required video data could be obtained by reading the snapshot header file 32 corresponding to the read instruction IN1 issued therefrom. In a further embodiment, all the built snapshot header file 32 related to the original video file 30 could be deleted by the server 100 after the recording procedure of the original video file 30 is completed, and, thereafter, the original video file 30 is provided as the output result CAP while receiving the read instruction IN1 requesting the original video file 30.

During the process performed for reading the snapshot header file 32, the read instruction IN2 issued from the client 150 would specify a specific range of the data to be read. Therefore, a starting address and an address offset used for reading the specific range of data could be obtained from content of the read instruction IN2 through a series of operations performed by the operating system or file system run in the server 100 for analyzing the read instruction IN2. When the target of the read instruction IN2 is the snapshot header file 32, the starting address of the data to be read is the starting address of the snapshot header file 32. Therefore, when the address offset is not greater than the size of the header information 320, the server 100 would provide a first content as the output result CAP to the client 150, wherein, the first content is the data located within the header information 320 and corresponded to the address offset such that the output result CAP is a part of the content of the header information 320 of the snapshot video file described above. Besides this, when the address offset is greater than the size of the header information 320, the server 100 would provide a second content as the output result CAP to the client 150, wherein the second content is the data located within the original video file pointed by the storage path and corresponded to the address offset such that the output result CAP is a part of the content of the original video file 30.

Through the technique solutions provided above, the video under recording could be provided to the client 150 without copying the recorded video to another file in the server 100. Furthermore, because the UMIDs of the videos provided during and after recording are different from each other, operation confusion occurred due to UMID could be prevented accordingly.

As known by those with ordinary skill in the art, the server 100 can be any electronic device that can receive, store, and provide electronic data to the outside and perform the operations described above, such as a Samba file server or a personal computer, etc. On the other hand, the client 150 can be any electronic device that can exchange electronic signals with the server 100 and perform the operations described above, such as a personal computer or a mobile device. The server 100 can run any appropriate operating system, such as a Unix operating system or a Linux operating system, and the file access mechanism between the server 100 and the client 150 can be designed by using any appropriate interface, for example, the design can be based on the Filesystem in Userspace (FUSE).

According to the description made above, it can be understood that, by using the technique solutions provided above, the method and system for generating snapshot of video under recording need not copy the content of the original video file that is under recording but generates a snapshot header file which occupies limited storage space. Therefore, the storage space would not be heavily wasted, and the efficiency of video playing and editing would not be affected by copying content of the original video file.

What is claimed is:

1. A method for generating snapshot of video under recording, which is adapted for providing a current content of an original video file when a read instruction is received while recording the original video, comprising:
retrieving a header information of the original video file stored in a server as a first header information when the read instruction requesting the original video file is received while recording the original video file;
replacing a first unique material identifier stored in the first header information with a second unique material identifier to form a second header information;
storing the second header information as a header information of a snapshot header file; and
generating a snapshot video file and providing the snapshot video file to a client when the snapshot header file is requested by the client,
wherein, a header information of the snapshot video file is generated in accordance with the second header information, and a snapshot content of the snapshot video file is generated by retrieving a part of the original video file defined by the snapshot header file.

2. The method according to claim 1, wherein the second header information includes a time length of the current content, a size of the current content and a number of frames of the current content.

3. The method according to claim 1, wherein the snapshot header file further comprises a metadata comprising a storage path where the original video file is stored in the server.

4. The method according to claim 3, wherein generating the snapshot video file and providing the snapshot video file to the client when the snapshot header file is requested by the client comprises:
providing a first content to the client when an address offset obtained due to requesting the snapshot header file is not greater than a size of the second header information, wherein the first content is a first data located within the second header information and corresponded to the address offset; and
providing a second content to the client when the address offset obtained due to requesting the snapshot header file is greater than the size of the second header information, wherein the second content is a second data located within the original video file pointed by the storage path and corresponded to the address offset.

5. A system for generating snapshot of video under recording, comprising:
a server being adapted for storing an original video file, wherein the original video file comprises a first header information, and a first unique material identifier; and
a client electrically coupled to the server,
wherein, when the original video file is under recording and a read instruction issued from the client for requesting the original video file is received by the server, the server retrieves the first header information, replaces a first unique material identifier stored in the first header information with a second unique material identifier to generate a second header information of a snapshot header file; and
when the snapshot header file is requested by the client, the server generates a snapshot video file and providing the snapshot video file to the, wherein, a header information of the snapshot video file is generated in accordance with the second header information, and a snapshot content of the snapshot video file is generated by retrieving a part of the original video file defined by the snapshot header file.

6. The system according to claim 5, wherein the second header information includes a time length of the current content, a size of the current content and a number of frame of the current content.

7. The system according to claim 5, wherein the snapshot header file further comprises a metadata comprising a storage path where the original video file is stored in the server.

8. The system according to claim 7, wherein the server provides a first content to the client when an address offset obtained due to requesting the snapshot header file is not greater than a size of the second header information, and provides a second content to the client when the address offset obtained due to requesting the snapshot header file is greater than the size of the second header information, wherein the first content is a data located within the second header information and corresponded to the address offset and the second content is a data located within the original video file pointed by the storage path and corresponded to the address offset.
